(19) United States
(12) Patent Application Publication
(10) Pub. No.: US 2007/0238613 A1
(43) Pub. Date: Oct. 11, 2007

(54) Dual band color forming composition and method

(76) Inventors: Andrew L. Van Brocklin, Corvallis, OR (US); Jayprakash C. Bhatt, Corvallis, OR (US); Makarand P. Gore, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/393,566

(22) Filed: Mar. 29, 2006

(51) Int. Cl. B41M 5/24

(52) U.S. Cl. 503/226

(57) ABSTRACT

A imageable coating includes a first thermochromic layer, a second thermochromic layer, and a thermal averaging layer disposed between said first thermochromic layer and said second thermochromic layer.

### BACKGROUND

Compositions that produce a color change upon exposure to energy in the form of light or heat are of great interest in generating images on a variety of substrates. For example, data storage media provide a convenient way to store large amounts of data in stable and mobile formats. For example, optical discs, such as compact discs (CDs), digital video disks (DVDs), or other discs allow a user to store relatively large amounts of data on a single relatively small medium. Data on such discs often includes entertainment, such as music and/or images, as well as other types of data. In the past, consumer devices were only configured to read the data stored on optical disks, not to store additional data thereon. Consequently, any data placed on the optical disks was frequently placed thereon by way of a large commercial machine that burned the data onto the disc. In order to identify the contents of the disc, commercial labels were frequently printed onto the disc by way of screen printing or other similar methods.

Recent efforts have been directed to providing consumers with the ability to store data on optical disks. Such efforts include the use of drives configured to burn data on recordable compact discs (CD-R), rewritable compact discs (CD-RW), recordable digital video discs (DVD-R), rewritable digital video discs (DVD-RW), and combination drives containing a plurality of different writeable drives, to name a few. These drives provide a convenient way for users to record relatively large amounts of data that may then be easily transferred or used in other devices.

The optical disks used as storage mediums frequently have two sides: a data side configured to receive and store data and a label side. The label side is frequently a background on which the user hand writes information to identify the disc.

### SUMMARY

An imageable system includes a first thermochromic layer, a second thermochromic layer, and a thermal averaging layer disposed between said first thermochromic layer and said second thermochromic layer.

Additionally, according to one exemplary embodiment, a method for forming an imageable coating includes providing a substrate, dispensing a first thermochromic material on the substrate, dispensing a thermal averaging material on the first thermochromic material, and dispensing a second thermochromic material on the thermal averaging material.

### BRIEF DESCRIPTION OF THE DRAWINGS

The accompanying drawings illustrate various embodiments of the present system and method and are a part of the specification. The illustrated embodiments are merely examples of the present system and method and do not limit the scope of the disclosure.

FIG. 1 illustrates a schematic view of a media processing system, according to one exemplary embodiment.

FIG. 2 is a side cross-sectional view of a laser imageable optical disc, according to one exemplary embodiment.

FIG. 3 is a flowchart illustrating a method of forming a laser imageable layer on an optical disc, according to one exemplary embodiment.

FIG. 4 is a flowchart illustrating a method for forming an image on an imageable disc, according to one exemplary embodiment.

FIG. 5 illustrates related graphs demonstrating the effects of a light source forming an image on a first layer of an imageable disc, according to one exemplary embodiment.

FIG. 6 illustrates related graphs demonstrating the effects of a light source forming an image on a second layer of an imageable disc, according to one exemplary embodiment.

FIG. 7 is a side cross-sectional view of a laser imageable optical disc configured to generate color images, according to one exemplary embodiment.

Throughout the drawings, identical reference numbers designate similar, but not necessarily identical, elements.

### DETAILED DESCRIPTION

The present exemplary systems and methods provide for the preparation of an imageable thermochromic system that uses thermal averaging to differentiate between color generation in a first or a second layer. In particular, an imageable thermochromic structure is described herein that can be selectively imaged in a first or a second layer with a single radiation generating device by varying the frequency and/or intensity of the radiation generating device. According to one exemplary embodiment, the present imageable thermochromic structure has two thermochromic coatings, each having different critical marking temperatures, separated by a thermal buffer layer. By placing the thermochromic coating having a higher critical marking temperature on the top of the exemplary structure, a radiation source may be pulsed at a high intensity to selectively radiate the top thermochromic layer. Additionally, the radiation source may provide uninterrupted radiation at a low intensity to selectively mark the lower thermochromic layer. Further details of the present markable structure, as well as exemplary methods for forming the structure on a desired substrate will be described in further detail below.

As used in the present specification, and in the appended claims, the term “imageable discs” is meant to be understood broadly as including, but in no way limited to, audio, video, multi-media, and/or software disks that are machine readable in a CD and/or DVD drive, or the like. Non-limiting examples of imageable disc formats include, writeable, recordable, and rewriteable disks such as DVD, DVD-R, DVD-RW, DVD+R, DVD+RW, DVD-RAM, CD, CD-ROM, CD-R, CD-RW, and the like.

As used in the present specification, and in the appended claims, the term “thermochromic” shall be interpreted broadly as including any material that is configured to change color when exposed to a temperature equal to, or higher than, a critical color changing temperature.

For purposes of the present exemplary systems and methods, the term “color” or “colored” refers to absorbance and reflectance properties that are preferably visible, including properties that result in black, white, or traditional color appearance. In other words, the terms “color” or “colored” includes black, white, and traditional colors, as well as other visual properties, e.g., pearlescence, reflectivity, translucence, transparency, etc.

In the following description, for purposes of explanation, numerous specific details are set forth in order to provide a thorough understanding of the present systems and methods for forming an imageable thermochromic structure configured to differentiate between at least two imageable layers using thermal averaging. It will be apparent, however, to one skilled in the art that the present systems and methods may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Exemplary Structure

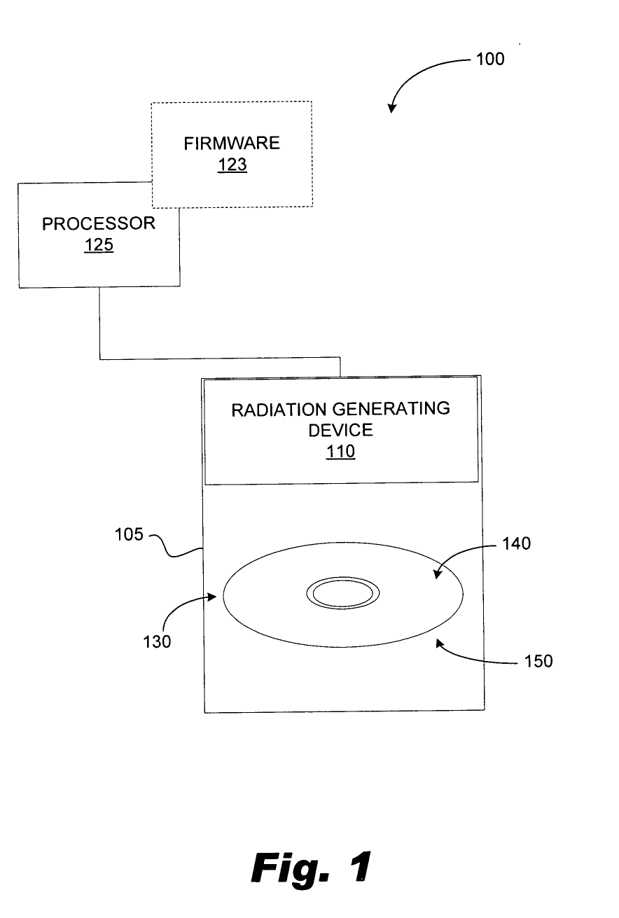

FIG. 1 illustrates a schematic view of a media processing system (100), according to one exemplary embodiment. As will be described in more detail below, the illustrated media processing system (100) can irradiate an imageable coating surface of the present exemplary compositions, register an image on the coatings, and use the imaged object for a variety of purposes. For example, according to one exemplary embodiment, an imageable data storage medium (imageable disc) may be inserted into the media processing system (100) to have data stored and/or a graphic image formed thereon. As used herein, for ease of explanation only, the present imageable thermochromic coating including thermal averaging will be described in the context of coating an optical disc such as a compact disc (CD) or a digital video disc (DVD). However, it will be understood that the present imageable thermochromic coating including thermal averaging may be applied to any number of desired substrates including, but in no way limited to, polymers, papers, metal, glass, ceramics, and the like.

As illustrated in FIG. 1, the media processing system (100) includes a housing (105) that houses a radiation generating device (110), which may be controllably coupled to a processor (125). The operation of the radiation generating device (110) may be controlled by the processor (125) and firmware (123) configured to selectively direct the operation of the radiation generating device. The exemplary media processing system (100) also includes hardware (not shown), such as spindles, motors, and the like, for placing an imageable disc (130) in optical communication with the radiation generating device (110). The operation of the hardware (not shown) may also be controlled by firmware (123) accessible by the processor (125). The above-mentioned components will be described in further detail below.

As illustrated in FIG. 1, the media processing system (100) includes a processor (125) having firmware (123) associated therewith. As shown, the processor (125) and firmware (123) are shown communicatively coupled to the radiation generating device (110), according to one exemplary embodiment. Exemplary processors (125) that may be associated with the present media processing system (100) may include, without limitation, a personal computer (PC), a personal digital assistant (PDA), an MP3 player, or other such device. According to one exemplary embodiment, any suitable processor may be used, including, but in no way limited to a processor configured to reside directly on the media processing system. Additionally, as graphically shown in FIG. 1, the processor (125) may have firmware (123) such as software or other drivers associated therewith, configured to control the operation of the radiation generating device (110) to selectively apply radiation to the data storage medium (130). According to one exemplary embodiment, the firmware (123) configured to control the operation of the radiation generating device (110) may be stored on a data storage device (not shown) communicatively coupled to the processor (125) including, but in no way limited to, read only memory (ROM), random access memory (RAM), and the like.

As introduced, the processor (125) is configured to controllably interact with the radiation generating device (110). While FIG. 1 illustrates a single radiation generating device (110), any number of radiation generating devices may be incorporated in the media processing system (100). According to one exemplary embodiment, the radiation generating device (110) may include, but is in no way limited to one or more lasers configured for forming data on a CD and/or DVD. The one or more lasers may be specifically configured to radiate one of a CD or a DVD. Alternatively, the one or more lasers of the radiation generating device (110) may include multiple lasers operating at different wavelengths, such as in a combo CD/DVD recording drive. More specifically, a combo CD/DVD recording drive configured to record on more than one type of media may be incorporated by the media processing system (100). For example, a DVD-R/RW (±) combo drive is also capable of recording CD-R/RW for example. In order to facilitate recording on more than one type of media, these combo CD/DVD recording drives include more than one laser. For example combo CD/DVD recording drives often contain 2 recording lasers: a first laser operating at approximately 780 nm for CD recordings and a second laser operating at approximately 650 nm for DVD recordings. Accordingly, the present media processing system (100) may include any number of lasers having wavelengths that may vary from between approximately 200 nm to approximately 1200 nm.

As mentioned previously, the present media processing system (100) includes a data storage medium in the form of a radiation imageable disc (130) disposed adjacent to the radiation generating device (110). According to one exemplary embodiment, the exemplary imageable disc (130) includes first (140) and second (150) opposing sides. The first side (140) has a data surface formed thereon configured to store data while the second side (150) includes an imageable surface having a plurality of color forming compositions.

With respect to the first side (140) of the imageable disc (130), the radiation generating device (110) may be configured to read existing data stored on the imageable disc (130) and/or to store new data on the imageable disc (130), as is well known in the art. As used herein, the term “data” is meant to be understood broadly as including the non-graphic information digitally or otherwise embedded on an imageable disc. According to the present exemplary embodiment, data can include, but is in no way limited to, audio information, video information, photographic information, software information, and the like. Alternatively, the term “data” may also be used herein to describe information such as instructions a computer or other processor may access to form a graphic display on an imageable surface.

In contrast to the first side of the imageable disc (130), the second side of the imageable disc (140) includes a plurality of imageable coatings including a thermal averaging layer separating the plurality of imageable coatings. According to one exemplary embodiment, discussed in further detail below, the second side of the imageable disc (140) includes two separate thermochromic layers: a bottom thermochromic layer having a relatively low marking temperature, and a top thermochromic layer having a relatively high marking temperature and an optional sensitizing agent in the form of an antenna dye or other radiation absorbing species dispersed in the top thermochromic layer. Further details of the radiation-curable imageable coating including thermal averaging will be provided below.

Exemplary Coating Formulation

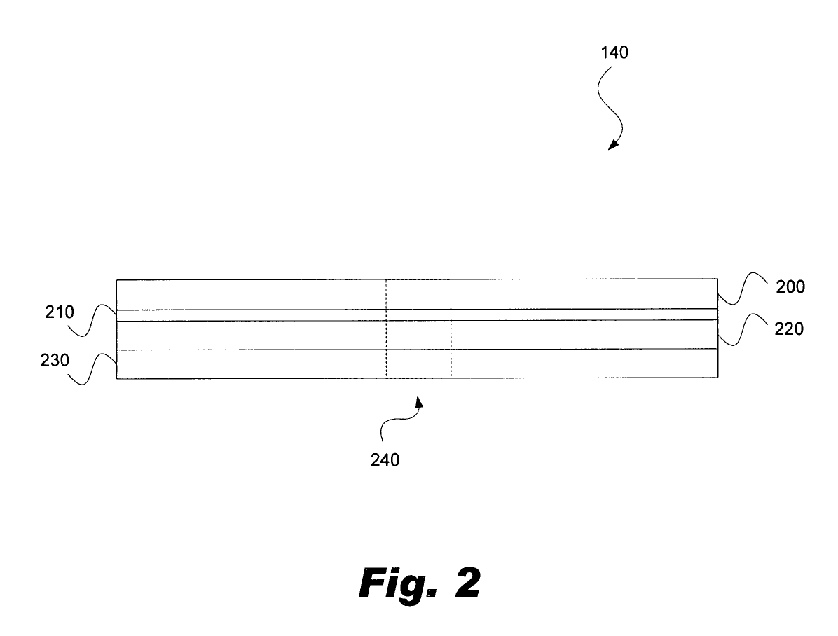

As mentioned above, the second side of the imageable disc (140) includes a plurality of layers including a top and a bottom thermochromic layer separated by a thermal averaging layer. FIG. 2 illustrates a cross-sectional view of the present exemplary imageable disc (140). As illustrated, the exemplary imageable disc (140) includes a center orifice (240) that extends through the entire body of the disc (140). The center orifice (240) facilitates the mounting of the disc (140) onto a disc drive or disc spindle, as is known in the art. As shown, the present exemplary imageable disc (140) includes a number of layers. Specifically, the bottom layer of the disc structure includes an optical disc data portion (230) including any number of the traditional structural layers included in a standard or writeable optical disc including, but in no way limited to, a polycarbonate plastic layer, recordable metallic layers, and/or protective acrylic layers. On top of the optical disc data portion (230) is formed a bottom thermochromic layer (220). Formed on top of the bottom thermochromic layer (220) is a thermal averaging layer (210) configured to slow the diffusion of heat from the top thermochromic layer (200) to the bottom thermochromic layer (220). A top thermochromic layer (200) is formed on top of the thermal averaging layer (210). Further details of each of the thermochromic layers (220, 200), as well as the thermal averaging layer (210) will be provided below.

According to one exemplary embodiment, the two thermochromic layers (220, 200) forming the present coating structure include, but are in no way limited to, polymer matrices with acidic activator species dissolved therein and a low-melting eutectic of a leuco dye insoluble or having low solubility at ambient temperature in the matrix, but uniformly distributed therein as a fine dispersion. Additionally, the top thermochromic layer may be sensitized to one or more radiation generating devices by the inclusion of an antenna dye package uniformly distributed/dissolved in at least one and preferably both phase(s) of the top layer (200). According to one exemplary embodiment, the present antenna dye package dispersed in the top thermochromic layer (200) includes a dye having an absorbance maximum corresponding to a wavelength value of a known radiation generating device (110; FIG. 1). Each of the phases of the thermochromic layers (200, 220) and the antenna dye package of the top thermochromic layer (200) will be described in detail below.

As mentioned, the first phase in each of the imageable thermochromic layers (200, 220) includes, but is in no way limited to, a polymer matrix with acidic activator species dissolved therein. According to one exemplary embodiment, the polymer in each of the thermochromic layers (200, 220) may be a lacquer configured to form a continuous phase, referred to herein as a matrix phase, when exposed to heat and/or light. More specifically, according to one exemplary embodiment, top imageable thermochromic layer (200) includes a radiation curable polymer that may include, by way of example, UV-curable matrices such as acrylate derivatives, oligomers, and monomers, with a photo package. A photo package may include a light absorbing species, such as photoinitiators, which initiate reactions for curing of the lacquer, such as, by way of example, benzophenone derivatives. Other examples of photoinitiators for free radical polymerization monomers and pre-polymers include, but are not limited to, thioxanethone derivatives, anthraquinone derivatives, acetophenones, benzoine ethers, and the like. Alternatively, because the bottom thermochromic layer (220) does not receive any significant radiation during the image formation process, the bottom thermochromic layer (200) may include, but is in no way limited to, thermally curable polymers. According to one exemplary embodiment, the thermally curable polymers undergo cure at a temperature substantially below the temperature required for image formation in bottom thermochromic layer (220).

According to one exemplary embodiment, the polymer matrix phases may be chosen such that curing is initiated by a form of radiation or a heat level that does not cause a color change of the color-former present in the coating, according to the present exemplary system and method. For example, the radiation-curable polymer matrix may be chosen such that the above-mentioned photo package initiates reactions for curing of the lacquer when exposed to a light having a different wavelength than that of the leuco dyes. According to one exemplary embodiment, the photo package may initiate reactions at a significantly shorter wavelength then that of the leuco dyes, such as UV or near UV radiation. Matrices based on cationic polymerization resins may require photoinitiators based on aromatic diazonium salts, aromatic halonium salts, aromatic sulfonium salts, and metallocene compounds. Additionally, matrices based on free radical polymerization may further include free radical photoinitiators such as benzophenons, alphahydroxy ketones, isopropylthioxanthones, and the like. Consequently, an example of a suitable lacquer or matrix may include Nor-Cote CLCDG-1250A (a mixture of UV curable acrylate monomers and oligomers) which contains a photoinitiator (hydroxyl ketone) and organic solvent acrylates, such as, methyl methacrylate, hexyl methacrylate, beta-phenoxy ethyl acrylate, and hexamethylene acrylate. Other suitable components for lacquers or matrices may include, but are not limited to, acrylated polyester oligomers, such as CN293 and CN294 as well as CN-292 (low viscosity polyester acrylate oligomer), trimethylolpropane triacrylate commercially known as SR-351, isodecyl acrylate commercially known as SR-395, and 2(2-ethoxyethoxy)ethyl acrylate commercially known as SR-256, all of which are available from Sartomer Co. Similarly, the bottom thermochromic layer (220) may include a thermally curable polymer matrix that is configured to be cured at a temperature other than the temperature desired for initiating color change.

Additionally, a number of acidic developers may be dispersed/dissolved in each of the present polymer matrices. According to one exemplary embodiment, the acidic developers present in the polymer matrices may include a phenolic species that is soluble or partially soluble in the coating matrix while being configured to develop color when reacting with a leuco dye through proton transfer. Suitable developers for use with the present exemplary system and method include, but are in no way limited to, acidic phenolic compounds such as, for example, Bis-Phenol A, p-Hydroxy Benzyl Benzoate, Bisphenol S (4,4-Dihydroxydiphenyl Sulfone), 2,4-Dihydroxydiphenyl Sulfone, Bis(4-hydroxy-3-allylphenyl)sulfone (Trade name—TG-SA), 4-Hydroxyphenyl-4′-isopropoxyphenyl sulfone (Trade name—D8). The acidic developer may be either completely or at least partially dissolved in the polymer matrices.

The second phase of each of the thermochromic layers is a color-former phase including, according to one exemplary embodiment, a leuco dye and/or leuco dye alloy, further referred to herein as a leuco-phase. According to one exemplary embodiment, the leuco-phase is present in the form of small particles dispersed uniformly in each of the thermochromic layers. According to one exemplary embodiment, the leuco-phase includes leuco dye or alloy of leuco dye with a mixing aid configured to form a lower melting eutectic with the leuco dye. Alternatively, according to one embodiment, the second phase of each of the present polymer matrices may include other color forming dyes such as photochromic dyes.

According to one exemplary embodiment, the present thermochromic layers may have any number of leuco dyes including, but in no way limited to, fluorans, phthalides, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids (cyanoethanes, leuco methines) and corresponding esters, 2(phydroxyphenyl)-4,5-diphenylimidazoles, indanones, leuco indamines, hydrozines, leuco indigoid dyes, amino-2,3-dihydroanthraquinones, tetrahalop, p′-biphenols, 2(p-hydroxyphenyl)-4,5-diphenylimidazoles, phenethylanilines, and mixtures thereof. According to one particular aspect of the present exemplary system and method, the leuco dye can be a fluoran, phthalide, aminotriarylmethane, or mixture thereof. Several nonlimiting examples of suitable fluoran based leuco dyes include, but are in no way limited to, 3-diethylamino-6-methyl-7-anilinofluorane, 3-(N-ethyl-p-toluidino)-6-methyl-7-anilinofluorane, 3-(N-ethyl-N-isoamylamino)-6-methyl-7-anilinofluorane, 3-diethylamino-6-methyl-7-(o,p-dimethylanilino)fluorane, 3-pyrrolidino-6-methyl-7-anilinofluorane, 3-piperidino-6-methyl-7-anilinofluorane, 3-(N-cyclohexyl-Nmethylamino)-6-methyl-7-anilinofluorane, 3-diethylamino-7-(mtrifluoromethylanilino)fluorane, 3-dibutylamino-6-methyl-7-anilinofluorane, 3-diethylamino-6-chloro-7-anilinofluorane, 3-dibutylamino-7-(o-chloroanilino)fluorane, 3-diethylamino-7-(o-chloroanilino)fluorane, 3-di-n-pentylamino-6-methyl-7-anilinofluoran, 3-di-n-butylamino-6-methyl-7-anilinofluoran, 3-(n-ethyln-isopentylamino)-6-methyl-7-anilinofluoran, 3-pyrrolidino-6-methyl-7-anilinofluoran, 1(3H)-isobenzofuranone,4,5,6,7-tetrachloro-3,3-bis[2-[4-(dimethylamino)phenyl]-2-(4-methoxyphenyl)ethenyl], and mixtures thereof.

Aminotriarylmethane leuco dyes can also be used in the present invention such as tris(N,N-dimethylaminophenyl)methane (LCV); deutero-tris(N,Ndimethylaminophenyl) methane (D-LCV); tris(N,N-diethylaminophenyl)methane (LECV); deutero-tris(4-diethylaminolphenyl)methane (D-LECV); tris (N,N-di-n-propylaminophenyl) methane (LPCV); tris(N,N-dinbutylaminophenyl)methane (LBCV); bis(4-diethylaminophenyl)-(4-diethylamino-2-methyl-phenyl)methane (LV-1); bis(4-diethylamino-2-methylphenyl)-(4-diethylamino-phenyl)methane (LV-2); tris(4-diethylamino-2-methylphenyl)methane (LV-3); deutero-bis(4-diethylaminophenyl)-(4-diethylamino-2-methylphenyl)methane (D-LV-1); deutero-bis(4-diethylamino-2-methylphenyl) (4-diethylaminophenyl)methane (D-LV-2); bis(4-diethylamino-2-methylphenyl) (3,4-dimethoxyphenyl)methane (LB-8); aminotriarylmethane leuco dyes having different alkyl substituents bonded to the amino moieties wherein each alkyl group is independently selected from C1-C4 alkyl; and aminotriaryl methane leuco dyes with any of the preceding named structures that are further substituted with one or more alkyl groups on the aryl rings wherein the latter alkyl groups are independently selected from C1-C3 alkyl.

Additional leuco dyes can also be used in connection with the present exemplary system and method and are known to those skilled in the art. A more detailed discussion of appropriate leuco dyes may be found in U.S. Pat. Nos. 3,658,543 and 6,251,571, each of which are hereby incorporated by reference in their entireties. Additionally examples may be found in Chemistry and Applications of Leuco Dyes, Muthyala, Ramaiha, ed.; Plenum Press, New York, London; ISBN: 0-306-45459-9, incorporated herein by reference.

Additionally, according to one exemplary embodiment, a number of melting aids may be included with the above-mentioned leuco dyes. As used herein, the melting aids may include, but are in no way limited to, crystalline organic solids with melting temperatures in the range of approximately 50° C. to approximately 150° C., and preferably having melting temperature in the range of about 70° C. to about 120° C. In addition to aiding in the dissolution of the leuco dye and/or the antenna dye, the above-mentioned melting aid may also assist in reducing the melting temperature of the leuco dye and stabilize the leuco dye alloy in the amorphous state, or slow down the re-crystallization of the leuco dye alloy into individual components. Suitable melting aids include, but are in no way limited to, aromatic hydrocarbons (or their derivatives) that provide good solvent characteristics for leuco dye and antenna dyes used in the present exemplary systems and methods. By way of example, suitable melting aids for use in the current exemplary systems and methods include, but are not limited to, m-terphenyl, pbenzyl biphenyl, alpha-naphtol benzylether, 1,2-[bis(3,4]dimethylphenyl)ethane. In some embodiments, the percent of leuco dyes or other color-former and melting aid can be adjusted to minimize the melting temperature of the color-former phase without interfering with the development properties of the leuco dye. When used, the melting aid can comprise from approximately 2 wt % to approximately 25 wt % of the color-former phase.

According to one exemplary embodiment of the present exemplary system and method, the above-mentioned leuco-phase is uniformly dispersed/distributed in each of the thermochromic matrix phases as a separate phase. In other words, at ambient temperature, the leuco phase is practically insoluble in matrix phase. Consequently, the leuco dye and the acidic developer component of the matrix phase are contained in the separate phases and can not react with color formation at ambient temperature. However, upon heating with laser radiation, both phases melt and mix. Once mixed together, color is developed due to a reaction between the fluoran leuco dye and the acidic developer. According to one exemplary embodiment, when the leuco dye and the acidic developer react, proton transfer from the developer opens a lactone ring of the leuco dye, resulting in an extension of conjugate double bond system and color formation.

While the above-mentioned color formation is desired, selective color formation of specific portions of each of the thermochromic layers (200, 220) is desired. Consequently, according to one exemplary embodiment, the top thermochromic layer (200) may be sensitized with one or more antenna dyes. According to one exemplary embodiment, the antenna dyes comprise a number of radiation absorbers configured to optimize development of the color forming composition upon exposure to radiation at a predetermined exposure time, energy level, wavelength, etc. More specifically, the radiation absorbing antenna dyes may act as an energy antenna providing energy to surrounding areas of the resulting coating upon interaction with an energy source. However, various radiation absorbing dyes have varying absorption ranges and varying absorbency maximums where the antenna dye will provide energy most efficiently from a radiation source. Generally speaking, a radiation antenna that has a maximum light absorption at or in the vicinity of a desired development wavelength may be suitable for use in the present system and method.

As a predetermined amount of energy can be provided by the radiation generating device (110; FIG. 1) of the media processing system (100; FIG. 1), matching the radiation absorbing energy antenna to the radiation wavelength and intensities of the radiation generating device can optimize the image formation system. Optimizing the system includes a process of selecting components of the color forming composition used in the top thermochromic layer (200) that can result in a rapidly developable composition under a fixed period of exposure to radiation at a specified power. Further, with media processing systems (100) having a plurality of radiation generating devices, optimizing the system further includes selecting radiation absorbing antenna dyes that will allow an efficient selective application of radiation to the color forming composition by a plurality of radiation generating devices.

In order to sensitize the top thermochromic layer (200) described above to the radiation of the radiation generating device (110; FIG. 1) the above-mentioned antenna dye package may be uniformly distributed/dissolved in at least one and preferably both phase(s) of the thermochromic layer (200). According to one exemplary embodiment, the present antenna dye package includes at least one dye having an absorbance maximum corresponding to wavelength values of the radiation generating device (110; FIG. 1).

According to one exemplary embodiment, the media processing system (100) may include one or more radiation generating devices (110; FIG. 1) having lasers with wavelength values of between approximately 300 nm and 1000 nm, including, but in no way limited to, a blue or an indigo laser having wavelength values of approximately 300 nm to approximately 600 nm.

As mentioned, a number of dyes having varying absorbance maximums may be used in the above-mentioned coatings to act as radiation absorbing antenna dyes. According to one exemplary embodiment, radiation absorbing antenna dyes having absorbance maximums at approximately 780 nm that may be incorporated into the present antenna dye package include, but are in no way limited to, indocyanine IR-dyes such as IR780 iodide (Aldrich 42,531-1) (1) (3H-Indolium, 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propyl-, iodide (9Cl)), IR783 (Aldrich 54,329-2) (2) (2-[2-[2-Chloro-3-[2-[1,3-dihydro-3,3-dimethyl-1-(4-sulfobutyl)-2Hindol-2-ylidene]-ethylidene]-1-cyclohexen-1-yl]-ethenyl]-3,3-dimethyl-1-(4-sulfobutyl)-3H-indolium hydroxide, inner salt sodium salt). Additionally, phthalocyanine or naphthalocyanine IR dyes such as Silicon 2,3-naphthalocyanine bis(trihexylsiloxide) (CAS No. 92396-88-8) (Lambda max −775 nm) may be used.

Exemplary radiation absorbing antenna dyes having absorbance maximums at approximately 650 nm that may be incorporated into the present antenna dye package include, but are in no way limited to, dye 724 (3H-Indolium, 2-[5-(1,3-dihydro-3,3-dimethyl-1-propyl-2H-indol-2-ylidene)-1,3-pentadienyl]-3,3-dimethyl-1-propyl-, iodide)\ddot{}C(lambda max=642 nm), dye 683 (3H-Indolium, 1-butyl-2-[5-(1-butyl-1,3-dihydro-3,3-dimethyl-2H-indol-2-ylidene)-1,3-pentadienyl]-3,3-dimethyl-, perchlorate \ddot{}C (lambda max=642 nm), dyes derived from phenoxazine such as Oxazine 1 (Phenoxazin-5-ium, 3,7-bis (diethylamino)-, perchlorate) \ddot{}C (lambda max=645 nm), both of which are commercially available from “Organica Feinchemie GmbH Wollen.” Appropriate antenna dyes applicable to the present exemplary system and method may also include but are not limited to phthalocyanine dyes with light absorption maximum at/or in the vicinity of 650 nm.

Radiation antennae which can be incorporated into the present antenna dye package for optimization in the blue (˜405 nm) and indigo wavelengths can include, but are not limited to, aluminum quinoline complexes, porphyrins, porphins, and mixtures or derivatives thereof. Non-limiting specific examples of suitable radiation antenna can include 1-(2-chloro-5-sulfophenyl)-3-methyl-4-(4-sulfophenyl)azo-2-pyrazolin-5-one disodium salt (λmax=400 nm); ethyl 7-diethylaminocoumarin-3-carboxylate (λ max=418 nm); 3,3′-diethylthiacyanine ethylsulfate (λmax=424 nm); 3-allyl-5-(3-ethyl-4-methyl-2-thiazolinylidene) rhodanine (λ max=430 nm) (each available from Organica Feinchemie GmbH Wolfen), and mixtures thereof.

Non-limiting specific examples of suitable aluminum quinoline complexes can include tris(8-hydroxyquinolinato)aluminum (CAS 2085-33-8), and derivatives such as tris(5-cholor-8-hydroxyquinolinato)aluminum (CAS 4154-66-1), 2-(4-(1-methyl-ethyl)-phenyl)-6-phenyl-4H-thiopyran-4-ylidene)-propanedinitril-1,1-dioxide (CAS 174493-15-3),4,4′-[1,4-phenylenebis(1,3,4-oxadiazole-5,2-diyl)]bis N,N-diphenyl benzeneamine (CAS 184101-38-0), bis-tetraethylammonium-bis(1,2-dicyano-dithiolto)-zinc(II) (CAS 21312-70-9), 2-(4,5-dihydronaphtho[1,2-d]-1,3-dithiol-2-ylidene)4,5-dihydro-naphtho[1,2-d]1,3-dithiole, all available from Syntec GmbH.

Non-limiting examples of specific porphyrin and porphyrin derivatives can include etioporphyrin 1 (CAS 448-71-5), deuteroporphyrin IX 2,4 bis ethylene glycol (D630-9) available from Frontier Scientific, and octaethyl porphrin (CAS 2683-82-1), azo dyes such as Mordant Orange (CAS 2243-76-7), Merthyl Yellow (CAS 60-11-7), 4-phenylazoaniline (CAS 60-09-3), Alcian Yellow (CAS 61968-76-1), available from Aldrich chemical company, and mixtures thereof.

As mentioned above, the top thermochromic layer (200) and the bottom thermochromic layer (220) are separated by a middle thermal averaging layer (210). According to one exemplary embodiment, the thermal averaging layer (210) is configured to slow the diffusion of heat from the top thermochromic layer (200) to the bottom thermochromic layer (220) during image formation. Consequently, if the top thermochromic layer (220) is being pulsed to form a desired image, the pulses are averaged by the thermal averaging layer (210) to a temperature less than the peak temperature of the pulses. According to one exemplary embodiment, the thermal averaging layer (210) may be formed out of any number of materials configured to average pulsed temperature including, but in no way limited to, an acrylate or any number of polymers having a thickness and thermal conductivity tuned to averaging pulsed thermal energy. According to one exemplary embodiment, the thermal averaging layer (210) may include, but is in no way limited to, an aqueous polymer. Further, the aqueous polymer can contain any number of inorganic particles (sub-micron) or ceramic particles to act as heat sinks. Exemplary methods of forming the above-mentioned structure, as well as methods for forming images on the structure are described in further detail below.

Exemplary Coating Forming Method

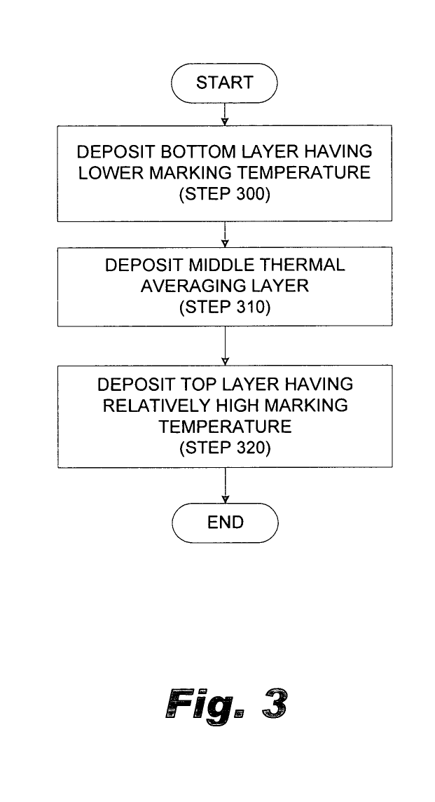

FIG. 3 is a flowchart illustrating a method of forming the present imageable thermochromic structure incorporating thermal averaging, according to one exemplary embodiment. In general, a method of forming each of the imageable thermochromic coatings includes preparing the radiation-curable polymer matrix with an acidic activator species dissolved therein, preparing a low-melting eutectic of a leuco dye, and evenly distributing the low-melting eutectic of a leuco dye in the radiation curable polymer matrix. Additionally, according to one exemplary embodiment, the preparation of the imageable thermochromic coating for the top layer (200) includes evenly distributing the radiation absorbing antenna dyes in the coating.

With each of the thermochromic coatings prepared for the two imageable thermochromic coatings (200, 220), the coatings may be formed on an optical disc data portion (230), as detailed in FIG. 3. According to the exemplary formation method illustrated in FIG. 3, the desired structure may be formed by first, depositing the bottom layer having a lower marking temperature (step 300) on an optical disc data portion (230; FIG. 2). Once the bottom layer has been formed, the middle thermal averaging layer may be deposited on the bottom layer (step 310), followed by the deposition of the top layer having a relatively high marking temperature (step 320). According to one exemplary embodiment, the above-mentioned thermochromic coatings and the thermal averaging layer may be applied to a desired substrate using any number of known coating systems and methods including, but in no way limited to, doctor blade coating, gravure coating, reverse roll coating, meyer rod coating, extrusion coating, curtain coating, air knife coating, and the like.

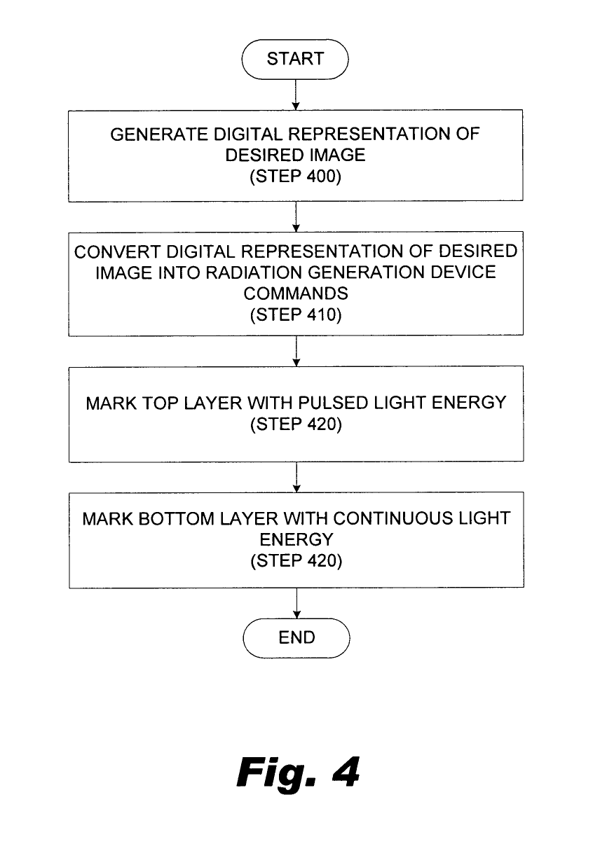

Once the above-mentioned structure is formed on the imageable disk (130; FIG. 1), data may be formed on the data surface of the first side (140), and/or a desired image may be formed via selective radiation exposure on the second side (150). FIG. 4 illustrates one exemplary method for forming a desired image on the second side (150) of the imageable disk (130), according to one exemplary embodiment. As illustrated in FIG. 4, the image formation method begins by first forming a digital representation of the desired image (step 400). According to one exemplary embodiment, forming the desired image may include forming a graphical representation of the desired image using any number of user interfaces. Once generated, the digital representation may be converted into radiation generation device commands (step 410). According to one exemplary embodiment, the desired image is separated into radiation generation device commands for forming images in the top thermochromic coating (200; FIG. 2) and the bottom thermochromic coating (220; FIG. 2) and converting the graphical representation into a number of machine controllable commands using the firmware (123; FIG. 1) and/or the processor (125; FIG. 1) of the media processing system (step 410).

Continuing with FIG. 4, the imageable disk may then be placed adjacent to the radiation generating device (110; FIG. 1) with the imageable thermochromic coatings adjacent to the radiation generating device. With the disc properly oriented adjacent to the radiation generating device, the imageable thermochromic coatings may then be selectively exposed to the radiation generating device to form the desired image. According to this exemplary embodiment, the formation of the desired image(s) on both the top thermochromic layer (200; FIG. 2) and the bottom thermochromic layer (220; FIG. 2) may be performed by marking the top thermochromic layer with pulsed light energy from the radiation generating device (step 420), and marking the bottom thermochromic layer with continuous light energy from the radiation generating device (step 430).

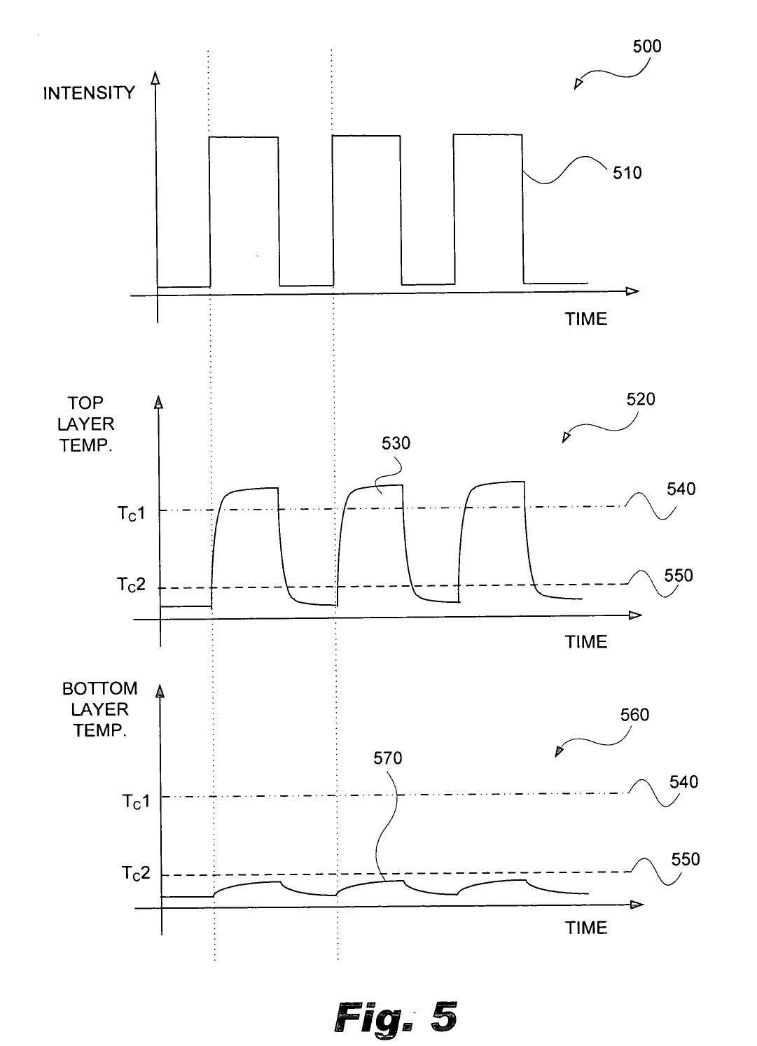

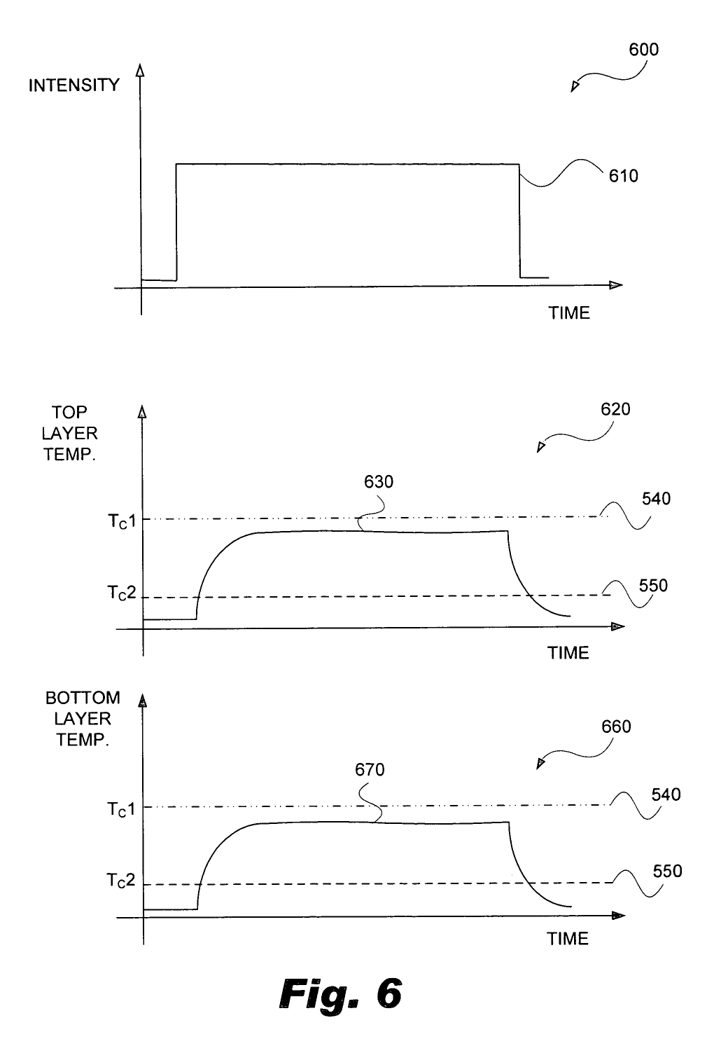

FIGS. 5 and 6 further detail the marking of the top and bottom thermochromic layers (200, 220; FIG. 2), according to one exemplary embodiment. FIG. 5 illustrates the effect of selectively marking the top thermochromic layer (200; FIG. 2) with pulsed light energy (step 420; FIG. 4), according to one exemplary embodiment. As detailed above, the top thermochromic layer (200; FIG. 2) has a higher critical marking temperature (540) than the critical marking temperature (550) of the bottom thermochromic layer. As illustrated in the laser intensity graph (500), the laser may be irradiated on the top thermochromic layer (200; FIG. 2) as pulsed light energy of a relatively high intensity (510), as illustrated.

The temperature v. time graph for the top thermochromic layer (520) illustrates the thermal effect of irradiating the disc with pulsed light energy. As illustrated in FIG. 5, the pulsed light will correspond to the antenna dye package incorporated in the top thermochromic layer (200; FIG.1). Consequently, the top layer will be rapidly absorb the high intensity light pulses (510) and convert them to heat in the top thermochromic layer (200; FIG. 1). As illustrated, the pulsed light (510) will be of sufficient intensity to rapidly raise the temperature of the top thermochromic layer (200; FIG. 1) above the high critical marking temperature (540) of the top thermochromic layer. Consequently, the desired color change and marking may be effected.

However, as illustrated in the temperature v. time graph for the bottom layer (560), the increase in temperature of the top thermochromic layer (200; FIG. 2) will be averaged by the properties of the thermal averaging layer (210; FIG. 2), thereby preventing the temperature of the bottom thermochromic layer (220; FIG. 2) from exceeding its lower critical marking temperature (550). Specifically, the thermal averaging layer (210; FIG. 2) reduces the thermal rise time coming from the heating in the top thermochromic layer (530) and consequently averages out the high irradiation pulses. Consequently, the pulsed light energy will only mark the top thermochromic layer (200; FIG. 2).

In contrast, FIG. 6 illustrates the marking of the bottom thermochromic layer (220; FIG. 2) in a manner that does not mark the top thermochromic layer (200; FIG. 2), according to the present exemplary system. As illustrated in FIG. 6, marking the bottom thermochromic layer (220; FIG. 2) includes irradiating the disc structure with a substantially continuous light energy (610) of a lower intensity than that of the light pulses (510; FIG. 5). As illustrated in the temperature v. time graph for the top thermochromic layer (620), the continuous light energy (610) is absorbed into the top thermochromic layer (200; FIG. 2), but is insufficient to raise the temperature (630) of the layer above the critical marking temperature of the top layer (540). However, as illustrated in the corresponding temperature v. time graph of the second thermochromic layer (660), the thermal averaging layer conducts the heat (630) from the top thermochromic layer (200; FIG. 2) to the bottom thermochromic layer (220; FIG. 2). Consequently, the bottom thermochromic layer (220; FIG. 2) is heated to a temperature (670) above the relatively low critical marking temperature (550) of that layer, thereby marking the layer.

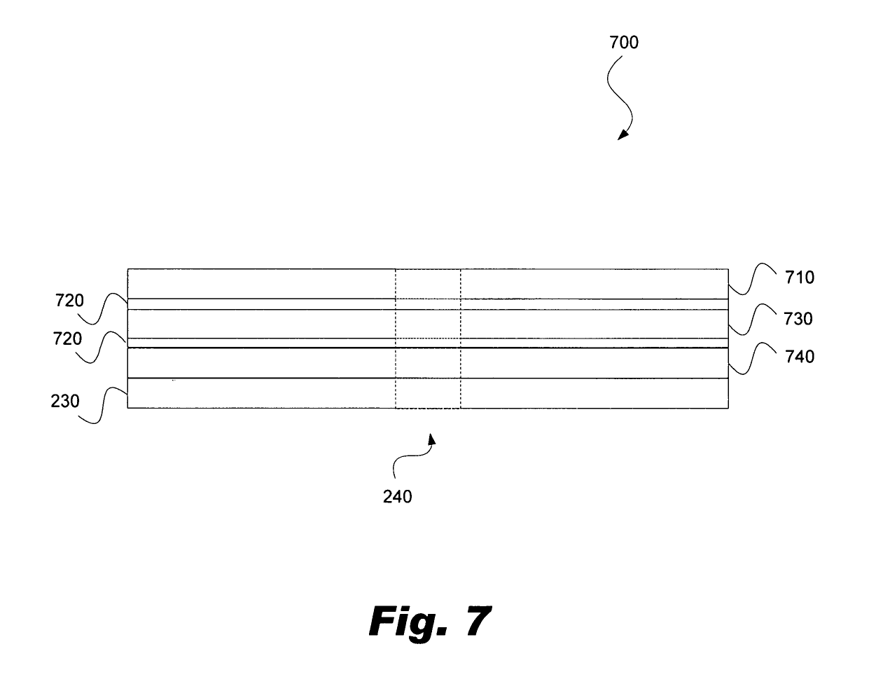

Additionally, according to one exemplary embodiment, the teachings of the present exemplary system may be applied to a full color marking system having three marking layers. Specifically, as illustrated in FIG. 7, a marking structure (700) may include a top thermochromic layer (710) having a relatively high critical marking temperature. Just below the top thermochromic layer (710) is positioned a thermal averaging layer (720) and a middle thermochromic layer (730) having an intermediate critical marking temperature. Below the middle thermochromic layer (730) is another thermal averaging layer (720) and a bottom thermochromic layer (740) having a relatively low critical marking temperature. According to this exemplary embodiment, the above-mentioned teachings may be used to selectively mark the various thermochromic layers illustrated in FIG. 7 by varying the frequency and intensity of a single radiation generating device. The top middle and bottom thermochromic layers (710, 730, 740) may each be configured, when marked, to generate one of a cyan, a magenta or a yellow color. Accordingly, a color image may be formed using traditional RGB color generation techniques.

In conclusion, the present exemplary systems and methods provide for the preparation and marking of an imageable thermochromic coating using a single radiation generating device, such as a laser. In particular, the present exemplary imageable coating has at least a first and second thermochromic layer, each having different critical marking temperatures. The at least first and second thermochromic layers are separated by a thermal averaging layer. Due to the above-mentioned structure and varying critical marking temperatures, each of the thermochromic layers may be selectively marked by varying the intensity and duration of a single radiation generating device.

The preceding description has been presented only to illustrate and describe the present method and apparatus. It is not intended to be exhaustive or to limit the disclosure to any precise form disclosed. Many modifications and variations are possible in light of the above teaching. It is intended that the scope of the disclosure be defined by the following claims.

What is claimed is:

1. An imageable coating, comprising:
a first thermochromic layer;
a second thermochromic layer; and
a thermal averaging layer disposed between said first thermochromic layer and said second thermochromic layer.

2. The imageable coating of claim 1, wherein said first thermochromic layer and said second thermochromic layer have different critical marking temperatures.

3. The imageable coating of claim 2, wherein:
said first thermochromic layer has a higher critical marking temperature than said second thermochromic layer; and
wherein said first thermochromic layer is oriented on top of said imageable coating.

4. The imageable coating of claim 3, wherein said first thermochromic layer further comprises an antenna dye package.

5. The imageable coating of claim 1, wherein each of said first thermochromic layer and said second thermochromic layer include:
a first phase including a polymer matrix and an activator disposed in said polymer matrix; and
a second phase insolubly distributed in said first phase, said second phase including a color-former.

6. The imageable coating of claim 5, wherein said color-former comprises a leuco dye, or a low-melting eutectic of one of a leuco dye or a leuco dye alloy.

7. The imageable coating of claim 6, wherein said color-former comprises a low-melting eutectic of a fluorane leuco dye.

8. The imageable coating of claim 1, wherein said thermal averaging layer comprises a polymer.

9. The imageable coating of claim 8, wherein said thermal averaging layer comprises an aqueous polymer.

10. the imageable coating of claim 9, wherein said aqueous polymer further comprises one of inorganic particles or ceramic particles.

11. The imageable coating of claim 1, further comprising:
a third thermochromic layer; and
a second thermal averaging layer disposed between said second thermochromic layer and said third thermochromic layer;
wherein said first thermochromic layer, said second thermochromic layer, and said third thermochromic layer are each configured to exhibit a different color when heated to a respective critical marking temperature;
wherein said critical marking temperature for each of said first thermochromic layer, said second thermochromic layer, and said third thermochromic layer differ.

12. The imageable coating of claim 11, wherein said first thermochromic layer, said second thermochromic layer, and said third thermochromic layer are each configured to exhibit one of a cyan, a magenta, a yellow color when heated to said respective critical marking temperature.

13. A method of forming an imageable coating comprising:
providing a substrate;
dispensing a first thermochromic material on said substrate;
dispensing a thermal averaging material on said first thermochromic material; and
dispensing a second thermochromic material on said thermal averaging material.

14. The method of claim 13, wherein said dispensing a first thermochromic material comprises coating said first thermochromic layer on said substrate with one of a doctor blade coating apparatus, a gravure coating apparatus, a reverse roll coating apparatus, a meyer rod coating apparatus, an extrusion coating apparatus, a curtain coating apparatus, or an air knife coating apparatus.

15. The method of claim 13, further comprising preparing said first thermochromic material prior to dispensing said first thermochromic material;
wherein preparing said first thermochromic material includes preparing a polymer matrix including an acid activator, forming a low-melting eutectic of a leuco dye phase, and distributing said low-melting eutectic of a leuco dye phase in said polymer matrix.

16. The method of claim 15, further comprising preparing said second thermochromic material prior to dispensing said second thermochromic material;
wherein preparing said second thermochromic material includes preparing a polymer matrix including an acid activator, forming a low melting eutectic of a leuco dye phase, distributing said low melting eutectic of a leuco dye phase in said polymer matrix, and sensitizing said second thermochromic material with an antenna dye package.

17. The method of claim 16, wherein said sensitizing said second thermochromic material with an antenna dye package further comprises distributing said antenna dye package in said polymer matrix.

18. The method of claim 16, wherein said sensitizing said second thermochromic material with an antenna dye package further comprises distributing said antenna dye package in said low-melting eutectic of a leuco dye phase.

19. A method of forming an image on a substrate comprising:
forming a imageable coating on a desired substrate, wherein said imageable coating includes a first thermochromic layer, a second thermochromic layer, and a thermal averaging layer disposed between said first thermochromic layer and said second thermochromic layer, wherein said first thermochromic layer and said second thermochromic layer have different critical marking temperatures;
selectively exposing said imageable coating to radiation of a first intensity and on time of exposure to image said first thermochromic layer; and
selectively exposing said imageable coating to radiation of a second intensity and on time of exposure to image said second thermochromic layer.

20. The method of claim 19, wherein said selectively exposing said imageable coating to radiation of a first intensity and on time to image said first thermochromic layer comprises irradiating said imageable coating with a pulsed light energy of a high intensity.

21. The method of claim 20, wherein said pulsed light energy is irradiated for a time insufficient to raise said second thermochromic layer above a critical marking temperature of said second thermochromic layer when averaged by said thermal averaging layer.

22. The method of claim 19, wherein said selectively exposing said imageable coating to a radiation of a second intensity and frequency of exposure to image said second thermochromic layer comprises irradiating said imageable coating with a substantially continuous light energy of a low intensity insufficient to raise said first thermochromic layer above its critical marking temperature.
